(19) United States
(12) Patent Application Publication
(10) Pub. No.: US 2026/0293928 A1
(43) Pub. Date: Oct. 1, 2026

(54) DRIED COCOA PULP COMPOSITION, CONSUMABLES AND METHODS

(71) Applicant: Givaudan SA, VERNIER (CH)

(72) Inventors: Tim EBERT, Kemptthal (CH); Gianluca GARZINO, Kemptthal (CH); Tobias WALLIMANN, Kemptthal (CH); Sebastien VEILLET, Avignon (FR)

(21) Appl. No.: 19/478,630

(22) PCT Filed: May 15, 2024
(86) PCT No.: PCT/EP2024/063443

§ 371 Date: Oct. 24, 2025

Related U.S. Application Data
(60) Provisional application No. 63/468,039, filed on May 22, 2023.

(51) Int. Cl. A23G 1/00; A23G 1/40; A23G 1/46; A23G 1/48

(52) U.S. Cl. CPC A23G 1/0016; A23G 1/40; A23G 1/46; A23G 1/48

(57) ABSTRACT

A composition including drum dried cocoa pulp, a carrier, and, optionally, at least one functional additive selected from natural flavor, sweet taste modifier, taste masker, and mouthfeel improver. Consumables including the composition and methods of making the composition and consumables are also disclosed. The drum dried cocoa pulp composition is used to prepare reduced sugar or zero sugar added chocolate consumables and edible chocolate end products and in methods to reduce or eliminate the addition of refined sugars to a consumable.

### TECHNICAL FIELD

The present disclosure relates to a composition ingredient for a consumable, a consumable including the composition ingredient, methods of making the ingredient composition and consumable including the ingredient composition. The present disclosure more particularly relates to a drum dried cocoa pulp composition ingredient for a consumable, a consumable including the drum dried cocoa pulp composition ingredient, methods of making the drum dried cocoa pulp ingredient composition and reduced sugar or zero added sugar consumables including the drum dried cocoa pulp ingredient composition.

### BACKGROUND

Chocolate is made from the cocoa bean (ie, cacao bean or simply cacao) from the cocoa tree Theobroma cacao. The fruit of Theobroma cacao is referred to as a fruit pod or cocoa pod. The cocoa pod has an outer husk that contains the cocoa bean (ie, cocoa seed) surrounded by mucilaginous pulp (ie, cocoa pulp). The cocoa pods are harvested from the Theobroma cacao tree and the husks are opened. The cocoa bean and surrounding cocoa pulp are separated from the husk of the pod and the husk is discarded. The coca bean is separated from the cocoa pulp for fermentation, roasting, and extraction of non-fat cocoa solids and cocoa fats. The cocoa pulp is largely discarded and constitutes a waste byproduct of the cocoa bean harvesting process. The non-fat cocoa solids and cocoa fat (i.e., cocoa butter) are extracted from the harvested and roasted cocoa beans to prepare chocolate.

There is a trend in the food and confectionary industry to respond to an increased awareness of health and wellness, which includes developing chocolate consumables and edible chocolate end products that have reduced refined sugar content or have zero added refined sugar. There have been nearly 300 new “low,” “reduced,” or “zero/no” sugar chocolate confectionary product launches since 2017. Mintel GNPD (Chocolate Confectionary), Europe, 2020.

The use of spray dried cocoa pulp has been proposed as a replacement for refined sugar in consumables. The use of dried cocoa pulp as a sugar replacer in consumables is associated with taste challenges in view of the strong acidity and astringency. Known cocoa pulp ingredients also do not provide the bulking volume or mouthfeel traditionally associated with sugar. Therefore, it remains desired in the art to provide an additive or ingredient for chocolate consumables that imparts sweet taste and mouthfeel (bulking volume) traditionally associated with sugar, overcomes the off-tastes (attributed to acidity and astringency) associated with known dried cocoa pulp, and that enables the reduction or total elimination of added refined sugars.

### BRIEF DESCRIPTION OF THE ILLUSTRATIVE DRAWINGS

FIG. 1 is a radar chart showing the perceived sensory attributes determined by the sensory evaluation of a milk-type chocolate consumable prepared with the inventive dried cocoa pulp composition as compared comparative milk-type chocolate and ruby-type chocolate consumables.

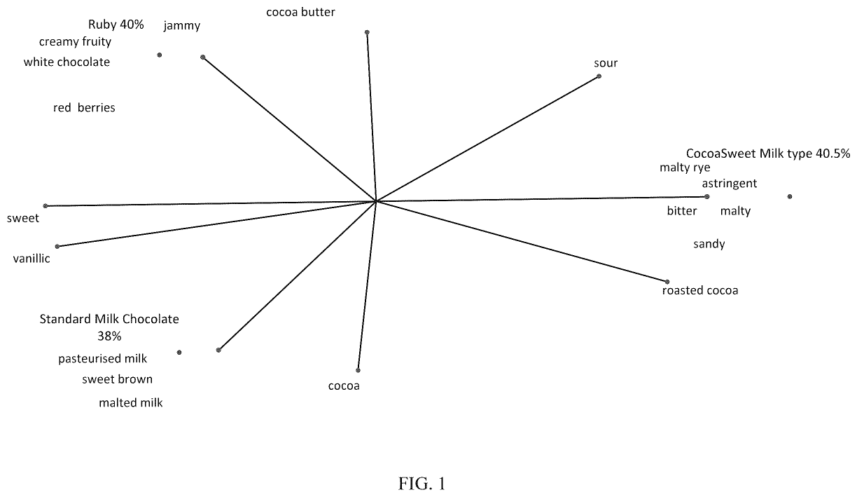

FIG. 2 is a bar chart summarizing the sensory evaluation of a milk-type chocolate consumable prepared with the inventive dried cocoa pulp composition as compared comparative milk-type chocolate and ruby-type chocolate consumables.

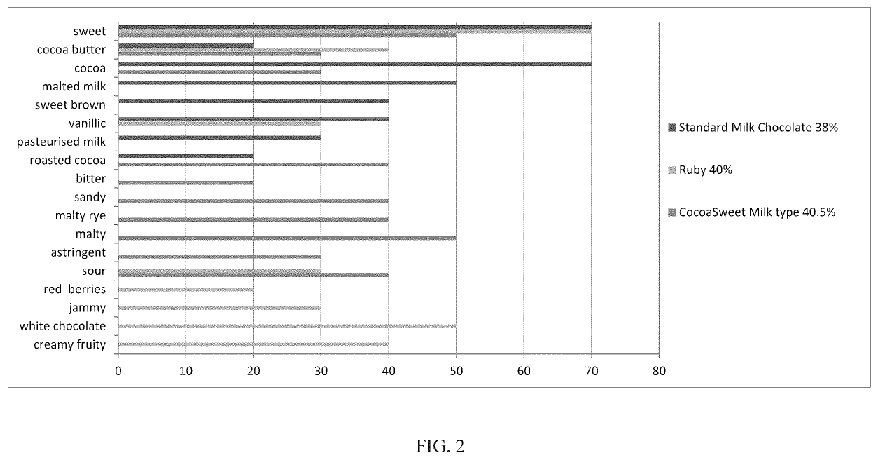

FIG. 3A is a column chart summarizing the sensory evaluation of the sour, astringent, bitter and sweet attributes of the milk-type chocolate consumable prepared with the inventive dried cocoa pulp composition as compared comparative milk-type chocolate and ruby-type chocolate consumables presented in FIG. 2.

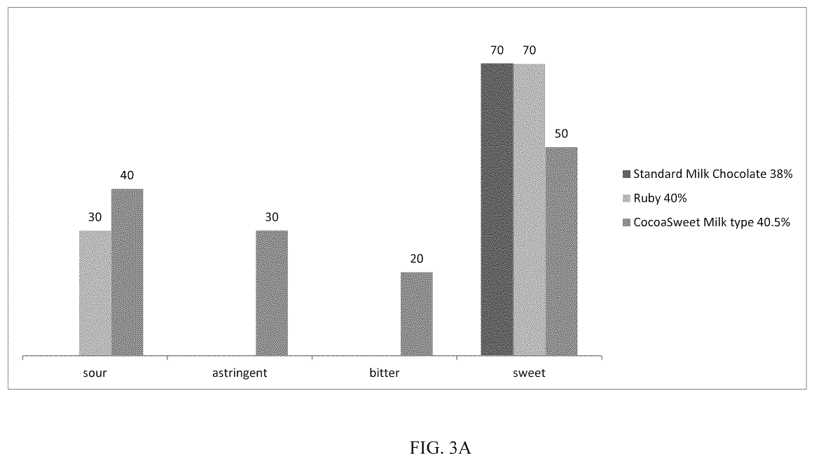

FIG. 3B is a column chart summarizing the sensory evaluation of the roasted cocoa, vanillic, sweet brown, cocoa, and cocoa butter attributes of the milk-type chocolate consumable prepared with the inventive dried cocoa pulp composition as compared comparative milk-type chocolate and ruby-type chocolate consumables presented in FIG. 2.

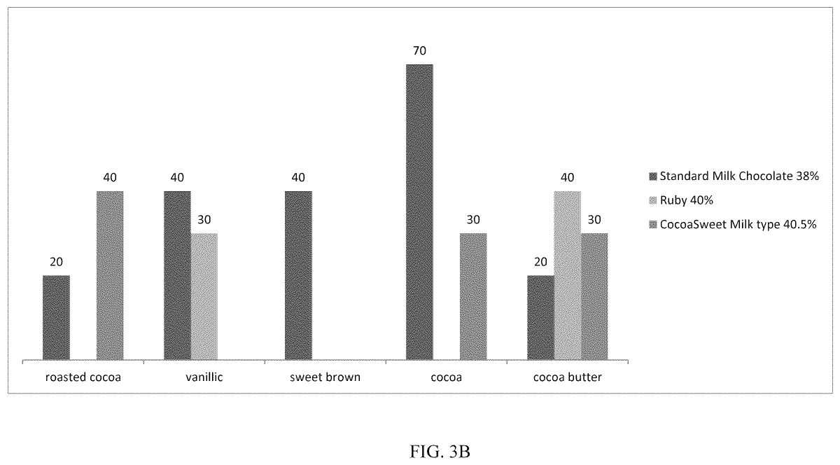

FIG. 4 is a radar chart showing the perceived sensory attributes determined by the sensory evaluation of a dark-type chocolate consumable prepared with the inventive dried cocoa pulp composition as compared comparative dark-type chocolate and whole cacao fruit-type chocolate consumables.

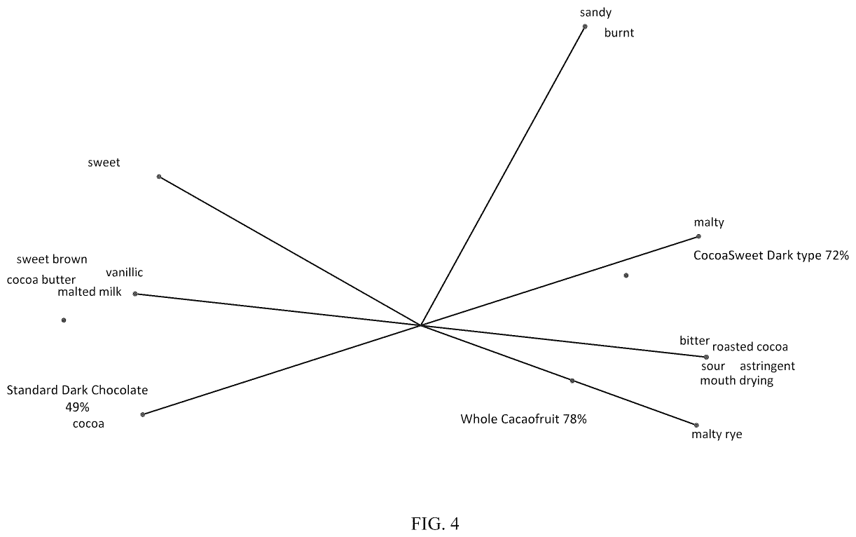

FIG. 5 is a bar chart summarizing the sensory evaluation of a dark-type chocolate consumable prepared with the inventive dried cocoa pulp composition as compared comparative dark-type chocolate and whole cacao fruit-type chocolate consumables.

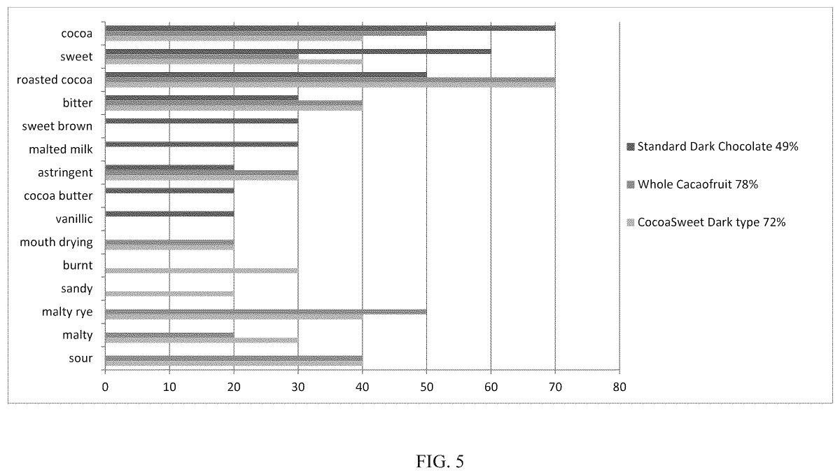

FIG. 6A is a column chart summarizing the sensory evaluation of the sour, astringent, bitter and sweet attributes of the dark-type chocolate consumable prepared with the inventive dried cocoa pulp composition as compared comparative dark-type chocolate and whole cacao fruit-type chocolate consumables presented in FIG. 5.

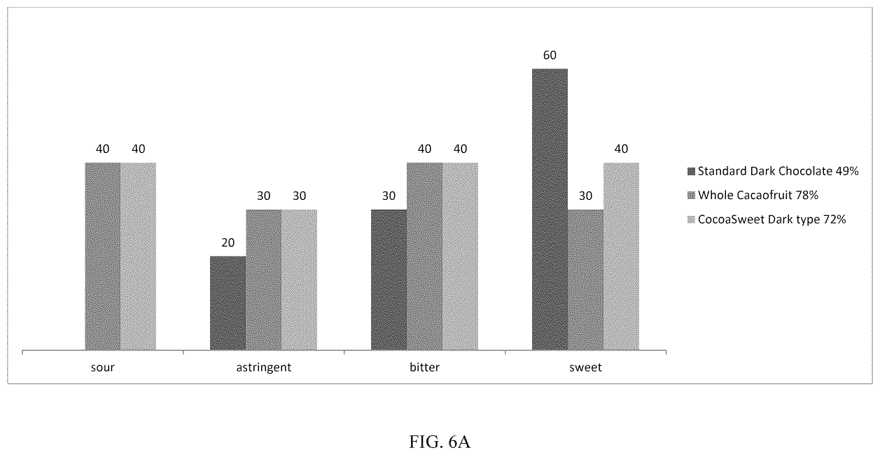

FIG. 6B is a column chart summarizing the sensory evaluation of the roasted cocoa, malty, malty rye, malted milk, vanillic, sweet brown, cocoa, and cocoa butter attributes of the dark-type chocolate consumable prepared with the inventive dried cocoa pulp composition as compared comparative dark-type chocolate and whole cacao fruit-type chocolate consumables presented in FIG. 5.

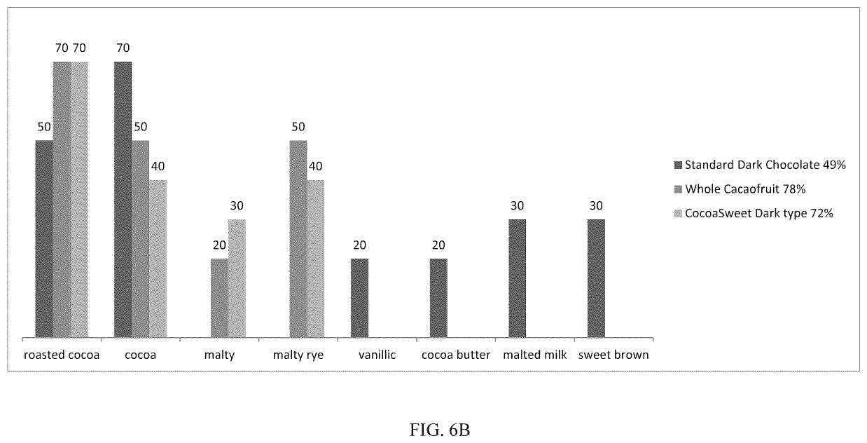

### SUMMARY OF ILLUSTRATIVE EMBODIMENTS

According to a first illustrative embodiment of the present disclosure, provided is a composition comprising drum dried cocoa pulp and at least one carrier selected from the group consisting of animal-derived milk powder, plant-derived milk powder and combinations thereof.

According to a second illustrative embodiment of the present disclosure, provided is a composition comprising dried cocoa pulp, at least one functional additive selected from natural flavor, sweet taste modifier, taste masker, mouthfeel improver, and combinations thereof, and at least one carrier.

According to a third illustrative embodiment of the present disclosure, provided is a method of making a drum dried cocoa composition comprising drum drying cocoa pulp in the presence of at least one carrier selected from the group consisting of animal-derived milk powder, plant-derived milk powder and combinations thereof.

According to a fourth illustrative embodiment of the present disclosure, provided is a consumable comprising a composition comprising drum dried cocoa pulp and at least one carrier selected from the group consisting of animal-derived milk powder, plant-derived milk powder and combinations thereof.

According to a fifth illustrative embodiment of the present disclosure, provided is a consumable comprising a composition comprising dried cocoa pulp, at least one functional additive selected from natural flavor, sweet taste modifier, taste masker, mouthfeel improver and combinations thereof, and at least one carrier.

According to a sixth illustrative embodiment of the present disclosure, provided is a consumable comprising a drum dried cocoa pulp composition prepared by the process of drum drying cocoa pulp with at least one carrier.

According to a seventh illustrative embodiment of the present disclosure, provided is a method for making a consumable comprising adding a composition comprising drum dried cocoa pulp and at least one carrier selected from the group consisting of animal-derived milk powder, plant-derived milk powder and combinations thereof to a consumable base.

According to an eighth illustrative embodiment of the present disclosure, provided is a method for making a consumable comprising adding a composition comprising dried cocoa pulp, at least one functional additive selected from natural flavor, sweet taste modifier, taste masker, mouthfeel improver and combinations thereof, and at least one carrier to a consumable base.

According to a ninth illustrative embodiment of the present disclosure, provided is a method for making a consumable comprising adding a composition prepared by the process of drum drying dried cocoa pulp with at least one carrier selected from the group consisting of animal-derived milk powder, plant-derived milk powder and combinations thereof, to a consumable base.

According to a tenth illustrative embodiment of the present disclosure, provided is a zero refined sugar containing consumable comprising a composition comprising a drum dried cocoa pulp and at least one carrier selected from the group consisting of animal-derived milk powder, plant-derived milk powder and combinations thereof.

According to an eleventh illustrative embodiment of the present disclosure, provided is a zero refined sugar containing consumable comprising a composition comprising dried cocoa pulp, at least one functional additive selected from natural flavor, sweet taste modifier, taste masker, mouthfeel improver and combinations thereof, and at least one carrier.

According to a twelfth illustrative embodiment of the present disclosure, provided is the use of a composition comprising drum dried cocoa pulp and at least one carrier selected from the group consisting of animal-derived milk powder, plant-derived milk powder and combinations thereof as an ingredient for a consumable.

According to a thirteenth illustrative embodiment of the present disclosure, provided is the use of a composition comprising dried cocoa pulp, at least one functional additive selected from natural flavor, sweet taste modifier, taste masker, mouthfeel improver and combinations thereof, and at least one carrier as an ingredient for a consumable.

According to a fourteenth illustrative embodiment of the present disclosure, provided is the use of a composition comprising drum dried cocoa pulp and at least one carrier selected from the group consisting of animal-derived milk powder, plant-derived milk powder and combinations thereof, as an ingredient to prepare a zero refined sugar added consumable.

According to a fifteenth illustrative embodiment of the present disclosure, provided is the use of a composition comprising dried cocoa pulp, at least one functional additive selected from natural flavor, sweet taste modifier, taste masker, mouthfeel improver and combinations thereof, and at least one carrier as an ingredient to prepare a zero refined sugar added consumable.

According to a sixteenth illustrative embodiment of the present disclosure, provided is the use of a composition comprising drum dried cocoa pulp and at least one carrier selected from the group consisting of animal-derived milk powder, plant-derived milk powder and combinations thereof, as an ingredient to prepare a reduced refined sugar consumable.

According to a seventeenth illustrative embodiment of the present disclosure, provided is the use of a composition comprising dried cocoa pulp, at least one functional additive selected from natural flavor, sweet taste modifier, taste masker, mouthfeel improver and combinations thereof, and at least one carrier as an ingredient to prepare a reduced refined sugar consumable.

According to am eighteenth illustrative embodiment of the present disclosure, provided is the use of a composition comprising drum dried cocoa pulp and at least one carrier selected from the group consisting of animal-derived milk powder, plant-derived milk powder and combinations thereof, as an ingredient to reduce the amount of refined sugar in a consumable.

According to a nineteenth illustrative embodiment of the present disclosure, provided is the use of a composition comprising dried cocoa pulp, at least one functional additive selected from natural flavor, sweet taste modifier, taste masker, mouthfeel improver and combinations thereof, and at least one carrier as an ingredient to reduce the amount of refined sugar in a consumable.

According to a twentieth illustrative embodiment of the present disclosure, provided is the use of a composition comprising drum dried cocoa pulp and at least one carrier selected from the group consisting of animal-derived milk powder, plant-derived milk powder and combinations thereof, as an ingredient to eliminate the inclusion of added refined sugar in a consumable.

According to a twenty-first illustrative embodiment of the present disclosure, provided is the use of a composition comprising dried cocoa pulp, at least one functional additive selected from natural flavor, sweet taste modifier, taste masker, mouthfeel improver and combinations thereof, and at least one carrier as an ingredient to eliminate the inclusion of added refined sugar in a consumable.

According to a twenty-second illustrative embodiment of the present disclosure, provided is method for reducing the amount of added refined sugar in a consumable comprising adding a composition comprising drum dried cocoa pulp and at least one carrier selected from the group consisting of animal-derived milk powder, plant-derived milk powder and combinations as an ingredient to a consumable base.

According to a twenty-third illustrative embodiment of the present disclosure, provided is method for reducing the amount of added refined sugar in a consumable comprising adding a composition comprising dried cocoa pulp, at least one functional additive selected from natural flavor, sweet taste modifier, taste masker, mouthfeel improver and combinations thereof, and at least one carrier as an ingredient to a consumable base.

According to a twenty-fourth illustrative embodiment of the present disclosure, provided is method for eliminating the addition of refined sugar in a consumable comprising adding a composition comprising drum dried cocoa pulp and at least one carrier selected from the group consisting of animal-derived milk powder, plant-derived milk powder and combinations, as an ingredient to a consumable base.

According to a twenty-fifth illustrative embodiment of the present disclosure, provided is method for eliminating the addition of refined sugar in a consumable comprising adding a composition comprising dried cocoa pulp, at least one functional additive selected from natural flavor, sweet taste modifier, taste masker, mouthfeel improver and combinations thereof, and at least one carrier as an ingredient to a consumable base.

According to a twenty-sixth illustrative embodiment of the present disclosure, provided is a composition comprising drum dried cocoa pulp and at least one carrier selected from the group consisting of animal-derived milk powder, plant-derived milk powder and combinations, wherein the cocoa pulp is a waste byproduct from a cocoa bean pod.

According to a twenty-seventh illustrative embodiment of the present disclosure, provided is a method of making a drum dried cocoa pulp composition comprising drum drying cocoa pulp with at least one carrier selected from the group consisting of animal-derived milk powder, plant-derived milk powder and combinations, wherein the cocoa pulp is a waste byproduct from a cocoa bean pod.

According to a twenty-eighth illustrative embodiment of the present disclosure, provided is a consumable comprising a composition comprising drum dried cocoa pulp and at least one carrier selected from the group consisting of animal-derived milk powder, plant-derived milk powder and combinations, wherein the cocoa pulp is a waste byproduct from a cocoa bean pod.

According to a twenty-nineth illustrative embodiment of the present disclosure, provided is a method of making a consumable comprising adding a composition comprising drum dried cocoa pulp and at least one carrier selected from the group consisting of animal-derived milk powder, plant-derived milk powder and combinations, wherein the cocoa pulp is a waste byproduct from a cocoa bean pod, to a consumable base.

According to a thirtieth illustrative embodiment of the present disclosure, provided is a zero refined sugar containing consumable comprising a composition comprising drum dried cocoa pulp and at least one carrier selected from the group consisting of animal-derived milk powder, plant-derived milk powder and combinations, wherein the cocoa pulp is a waste byproduct from a cocoa bean pod.

According to a thirty-first illustrative embodiment of the present disclosure, provided is the use of a composition comprising drum dried cocoa pulp and at least one carrier selected from the group consisting of animal-derived milk powder, plant-derived milk powder and combinations, wherein the cocoa pulp is a waste byproduct from a cocoa bean pod, as an ingredient for a consumable.

According to a thirty-second illustrative embodiment of the present disclosure, provided is the use of a composition comprising drum dried cocoa pulp and at least one carrier selected from the group consisting of animal-derived milk powder, plant-derived milk powder and combinations, wherein the cocoa pulp is a waste byproduct from a cocoa bean pod, an as an ingredient to prepare a zero refined sugar added consumable.

According to a thirty-third illustrative embodiment of the present disclosure, provided is the use of a composition comprising drum dried cocoa pulp and at least one carrier selected from the group consisting of animal-derived milk powder, plant-derived milk powder and combinations, wherein the cocoa pulp is a waste byproduct from a cocoa bean pod, an as an ingredient to prepare a reduced refined sugar added consumable.

According to a thirty-fourth illustrative embodiment of the present disclosure, provided is the use of a composition comprising drum dried cocoa pulp and at least one carrier selected from the group consisting of animal-derived milk powder, plant-derived milk powder and combinations, wherein the cocoa pulp is a waste byproduct from a cocoa bean pod, an as an ingredient to reduce the amount of refined sugar in a consumable.

According to a thirty-fifth illustrative embodiment of the present disclosure, provided is the use of a composition comprising drum dried cocoa pulp and at least one carrier selected from the group consisting of animal-derived milk powder, plant-derived milk powder and combinations, wherein the cocoa pulp is a waste byproduct from a cocoa bean pod, an as an ingredient to eliminate the inclusion of added refined sugar in a consumable.

According to a thirty-sixth illustrative embodiment of the present disclosure, provided is a method for reducing the amount of added refined sugar in a consumable comprising adding a composition comprising drum dried cocoa pulp and at least one carrier selected from the group consisting of animal-derived milk powder, plant-derived milk powder and combinations, wherein the cocoa pulp is a waste byproduct from a cocoa bean pod, as an ingredient to a consumable base.

According to a thirty-seventh illustrative embodiment of the present disclosure, provided is a method for eliminating the addition of refined sugar in a consumable comprising adding a composition comprising drum dried cocoa pulp and at least one carrier selected from the group consisting of animal-derived milk powder, plant-derived milk powder and combinations, wherein the cocoa pulp is a waste byproduct from a cocoa bean pod, as an ingredient to a consumable base.

The Summary of Illustrative Embodiments section of the present Specification is intended as a brief introduction to certain illustrative embodiments of the disclosure and should not be considered to limit the scope of the appended claims in any manner whatsoever.

### DESCRIPTION OF ILLUSTRATIVE EMBODIMENTS

It should be understood that when a range of values is described in the present disclosure, it is intended that any and every value within the range, including the end points, is to be considered as having been disclosed. For example, “a range of from 50 to 100” of a component is to be read as indicating each and every possible number along the continuum between 50 and 100. It is to be understood that the inventors appreciate and understand that any and all values within the range are to be considered to have been specified, and that the inventors have possession of the entire range and all the values within the range.

In the present disclosure, the term “about” used in connection with a value is inclusive of the stated value and has the meaning dictated by the context. For example, it includes at least the degree of error associated with the measurement of the particular value. One of ordinary skill in the art would understand the term “about” is used herein to mean that an amount of “about” of a recited value produces the desired degree of effectiveness in the compositions and/or methods of the present disclosure. One of ordinary skill in the art would further understand that the metes and bounds of “about” with respect to the value of a percentage, amount or quantity of any component in an embodiment can be determined by varying the value, determining the effectiveness of the compositions for each value, and determining the range of values that produce compositions with the desired degree of effectiveness in accordance with the present disclosure. The term “about” is further used to reflect the possibility that a composition may contain trace components of other materials that do not alter the effectiveness or safety of the composition.

The compositional weight percentages disclosed herein are based on the total weight of the ingredient composition and consumables, as the situation dictates. It will be understood to one of ordinary skill in the art that the total weight percent of the fat delivery systems or food product cannot exceed 100%. For example, a person of ordinary skill in the art would easily recognize and understand that a composition comprising 50 to 100 weight percent of a first component and 0 to 50 weight percent of a second component will not exceed 100%. A person of ordinary skill in the art would understand that the amount of the components may be adjusted within disclosed ranges to include the desired amount of the components without exceeding 100% by weight of the composition.

As used in this specification any reference to the phrases “one embodiment” or “an embodiment” means that a particular element, feature, structure, process step, or characteristic described in connection with the embodiment is included in at least one embodiment. The particular element, feature, structure, process step, or characteristic may, in fact, be included in more than one embodiment disclosed herein. Furthermore, the use of the phrase “in one embodiment” in various places in the specification does not necessarily all refer to the same embodiment.

As used in this specification, the terms “comprises,” “contains,” “containing,” “comprising,” “includes,” “including,” “has,” or “having,” are open-ended expressions and are intended to cover compositions, consumables, methods, processes, products, apparatus, or systems that comprise a recited list of components, elements, or features, and any and all additional components, elements or features that are not expressly recited.

As used in the present specification, the term “or” refers to an inclusive “or” and not to an exclusive “or”. For example, the phrase “A or B” is satisfied by any one of the following: A is present (element or method step) and B is not present (element or method step), A is not present (element or method step) and B is present (element or method step), or both A and B are present (element or process step).

As used in the present specification, “a” or “an” is employed to describe components, elements, features and method/process steps of various illustrative embodiments disclosed herein. The use of “a” or “an” should be interpreted to include one or more than one.

As used in the present specification, any of the terms “preferably,” “commonly,” and “typically” are not intended to, and do not, limit the scope of the disclosed compositions, consumables, methods, processes, or uses, or to imply that certain features are critical, essential, important, or required to the structure or function of the claimed compositions, consumables, methods, processes, or uses. Rather, these terms are merely intended to identify particular aspects of an embodiment or to emphasize alternative or additional features that may or may not be utilized in a particular embodiment.

According to certain embodiments, the ingredient compositions and consumable containing the ingredient composition are products that can be considered to be “clean-label” products. The “clean-label” movement is a consumer movement or trend driven by health and nutrition conscious consumers. The term “clean-label” is a term that has been adopted by the food industry, consumers, academics, and governmental regulatory agencies. A “clean-label” product is a food product that contains as few ingredients as possible, and which are generally recognized as natural, familiar, and simple ingredients. Consumers and the general public consider, perceive, or recognize the ingredients in the “clean-label” product as being healthy or wholesome, and not artificial, processed, synthetic, or to contain chemicals.

For the purposes of this specification, the term “sweet taste modifier” refers to one or more components that improves the sweet taste profile of a reduced refined sugar composition or consumable or zero refined sugar added consumable to more closely approximate the taste profile of a full sugar sweetened composition or sweetened consumable, including chocolate consumables.

For the purposes of this specification, the term “taste masker” refers to one or more components that conceal, hide, mask, or obscure undesired off-notes imparted by one or more components of the ingredient composition.

Mouthfeel refers to the physical sensations experienced or felt in the mouth that are created by food and beverages, or compositions added to food or beverages. Mouthfeel may refer to textures that come into contact with the tongue, roof of the mouth, teeth, gums, or throat. Mouthfeel is considered to be distinct from taste/flavor, but is considered to have an equal or even greater impact on a person's enjoyment or preference for certain foods over others. Typical mouthfeel descriptors used to describe perceived sensations include acidity (metallic, citrusy, bright), density (close, airy), dryness (arid, scorched), graininess (particulate, powdery, dusty, grainy, chalky), gumminess (chewy, tough), hardness (crunchy, soft), heaviness (full, weighty), irritation (prickly, stinging), mouth coating (oily, buttery), roughness (abrasive, textured), slipperiness (slimy, stringy), smoothness (creamy, satiny, velvety), uniformity (even, uneven) and viscosity (full-bodied, light-bodied). For the purposes of this specification, the term “mouthfeel improver” refers to one or more components that provide a mouthfeel of a consumable to more closely approximate the mouthfeel of a full sugar sweetened composition or sweetened consumable, including chocolate consumables.

Disclosed is an ingredient composition for a consumable. The composition comprises drum dried cocoa pulp and at least one carrier. According to certain illustrative embodiments, the composition consists essentially of drum dried cocoa pulp and at least one carrier. According to other illustrative embodiments, the composition consists of drum dried cocoa pulp and at least one carrier.

The composition may comprise dried cocoa pulp, at least one functional additive selected from natural flavor, sweet taste modifier, taste masker, mouthfeel improver and combinations thereof, and at least one carrier. According to certain illustrative embodiments, the composition consists essentially of dried cocoa pulp, at least one functional additive selected from natural flavor, sweet taste modifier, taste masker, mouthfeel improver and combinations thereof, and at least one carrier. According to other illustrative embodiments, the composition consists of dried cocoa pulp, at least one functional additive selected from natural flavor, sweet taste modifier, taste masker, mouthfeel improver and combinations thereof, and at least one carrier.

According to certain illustrative embodiments, the composition comprises drum dried cocoa pulp, at least one functional additive selected from natural flavor, sweet taste modifier, taste masker, mouthfeel improver and combinations thereof, and at least one carrier. According to certain illustrative embodiments, the composition consists essentially of drum dried cocoa pulp, at least one functional additive selected from natural flavor, sweet taste modifier, taste masker, mouthfeel improver and combinations thereof, and at least one carrier. According to other illustrative embodiments, the composition consists of drum dried cocoa pulp, at least one functional additive selected from natural flavor, sweet taste modifier, taste masker, mouthfeel improver and combinations thereof, and at least one carrier.

Without limitation, and only by way of illustration, the at least one carrier of the composition ingredient may be selected from animal-derived milk powder, plant-derived milk powder, and combinations thereof. Without limitation, the animal-derived milk powder is selected from animal-derived non-fat milk powder, animal-derived skim milk powder, animal-derived 2% milk powder, animal-derived 1% milk powder, animal-derived whole milk powder, and combinations thereof. According to other illustrative embodiments, the plant-derived milk powder is selected from nut milks, legume milks, seed milks, coconut milks, grain milks. Nut milks may include almonds, cashews, hazelnuts, macadamia nuts, peanut, pistachio, walnut, and combinations thereof. Grain milks may include oat milk, rice milk, barley milk, spelt and buckwheat and combinations thereof. Seed milks include hemp seed milk, pumpkin seed milk, sesame seed milk, sunflower seed milk, and combinations thereof. Legume milks include pea milk, soy milk, and combinations thereof.

The sweet taste modifier may comprise one or more of a wide variety compounds. According to certain illustrative embodiments, the sweet taste modifier of the composition comprises a betaine. A betaine is a zwitterionic quaternary ammonium compound of the following general formula and derivatives thereof:

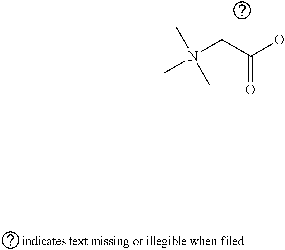

According to other illustrative embodiments, the sweet taste modifier of the composition comprises a compound of the following formula and derivatives thereof:

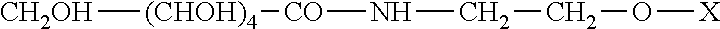

wherein X in the formula —OH, —O(CO)R, —OPO₃H₂, —PO₃H₂, —OSO₃H, —SO₃H, and R is a C₂-C₁₀ group containing at least one carboxylic acid group, and derivatives thereof. This substance is more fully described in WO2006/009428, which is incorporated herein by reference.

According to other illustrative embodiments, the sweet taste modifier of the composition comprises one or more carboxylic acid-amino acid conjugates of the following formula and derivatives thereof:

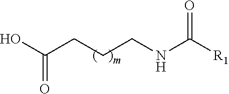

and edible derivatives thereof, wherein R¹ is an alkyl residue having from 6 to 30 carbon atoms, or an alkene residue containing from 9 to 25 carbon atoms with 1 to 6 double bonds together, R₁ with the carbonyl group to which it is attached is a residue of a carboxylic acid, m is 0 or 1. The edible derivatives may comprise an edible salt, including those typically used in the food and beverage industry, including, without limitation, chlorides, sulphates, phosphates, gluconates, sodium salts, citrates, carbonates, acetates and lactates. These carboxylic acid-amino acid conjugates are more fully described in WO2013/148991, which is incorporated herein by reference.

According to other illustrative embodiments, the sweet taste modifier of the composition comprises one or more carboxylic acid-amino acid conjugates of the following formula and derivatives thereof:

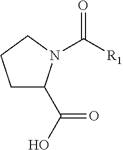

and edible derivatives thereof, wherein R₁ is an alkyl residue having from 6 to 30 carbon atoms, or an alkene residue containing from 9 to 25 carbon atoms with 1 to 6 double bonds together, R¹ with the carbonyl group to which it is attached is a residue of a carboxylic acid, m is 0 or 1.

The edible derivatives may comprise an edible salt, including those typically used in the food and beverage industry, including, without limitation, chlorides, sulphates, phosphates, gluconates, sodium salts, citrates, carbonates, acetates and lactates. These carboxylic acid-amino acid conjugates are more fully described in WO2013/149022, which is incorporated herein by reference.

According to other illustrative embodiments, the sweet taste modifier of the composition comprises one or more carboxylic acid-amino acid conjugates of the following formula and derivatives thereof:

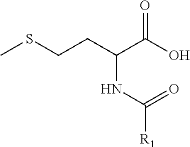

and edible derivatives thereof, wherein R₁ is an alkyl residue having from 6 to 30 carbon atoms, or an alkene residue containing from 9 to 25 carbon atoms with 1 to 6 double bonds together, R¹ with the carbonyl group to which it is attached is a residue of a carboxylic acid, m is 0 or 1. The edible derivatives may comprise an edible salt, including those typically used in the food and beverage industry, including, without limitation, chlorides, sulphates, phosphates, gluconates, sodium salts, citrates, carbonates, acetates and lactates. These carboxylic acid-amino acid conjugates are more fully described in WO2013/149019, which is incorporated herein by reference.

According to other illustrative embodiments, the sweet taste modifier of the composition comprises one or more of the compounds of the following formulas and derivatives thereof:

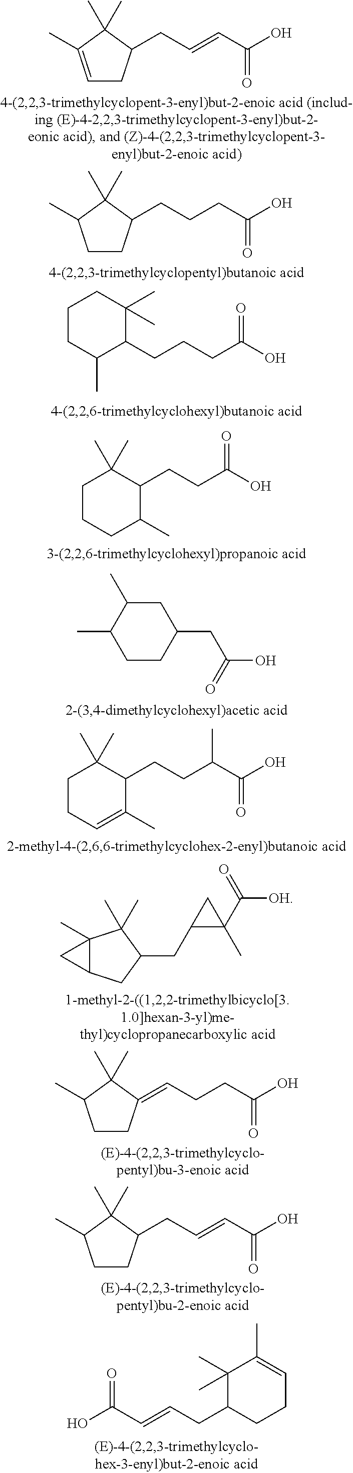

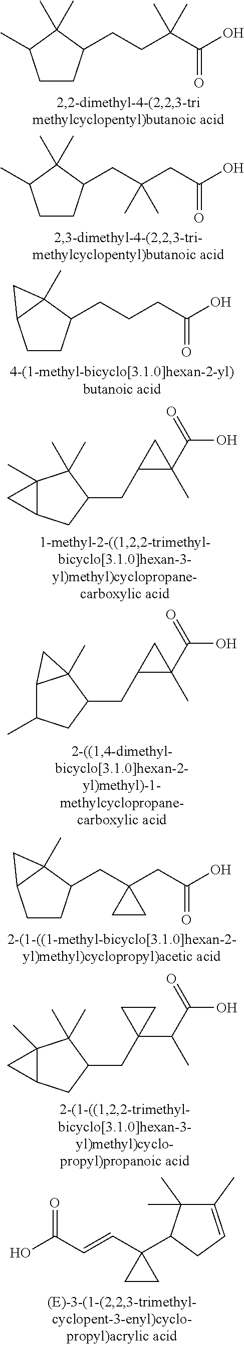

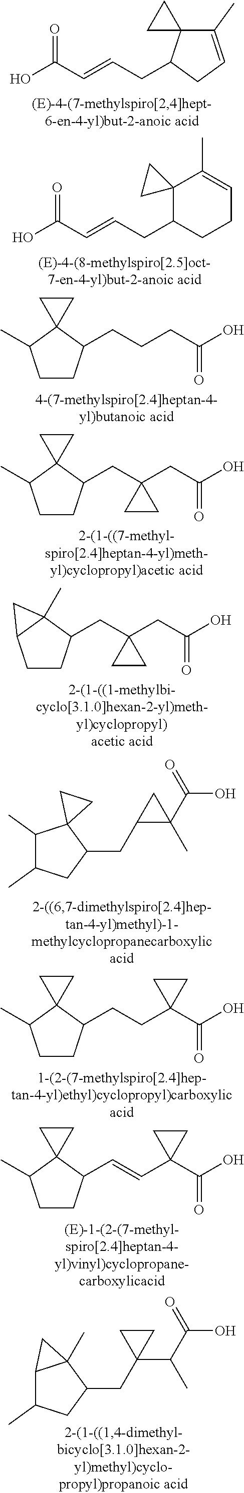

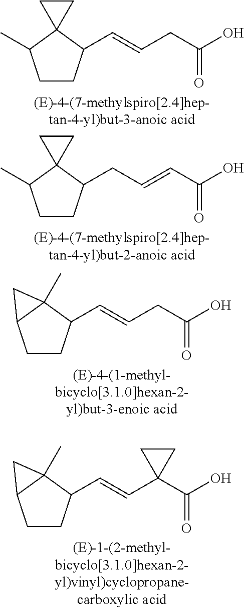

The above compounds are more fully described in WO2008/119197 and WO2008/119196, which are fully incorporated herein by reference.

According to other illustrative embodiments, the sweet taste modifier of the composition comprises one or more of a chlorogenic acid. The term chlorogenic acid refers to quinic acid conjugates comprising one or more compounds of a family of esters that form between cis and trans cinnamic acids (for example, caffeic acid, ferulic acid, p-coumaric acid, sinapic acid) and quinic acid. The quinic acid conjugates are represent by the following formula:

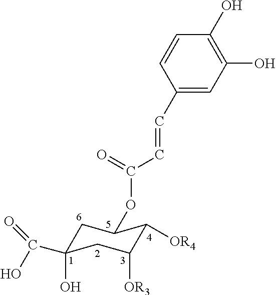

wherein certain illustrative quinic acid conjugates are defined by the R group substitutions shown in the following table:

| Identity of R3 | Identity of R4 | Identity of R5 |
|---|---|---|
| caffeic acid | H | H |
| H | caffeic acid | H |
| H | H | caffeic acid |
| ferulic acid | H | H |
| H | ferulic acid | H |
| H | H | ferulic acid |
| p-coumaric acid | H | H |
| H | p-coumaric acid | H |
| H | H | p-coumaric acid |
| caffeic acid | caffeic acid | H |
| caffeic acid | H | caffeic acid |
| H | caffeic acid | caffeic acid |
| caffeic acid | ferulic acid | H |
| ferulic acid | caffeic acid | H |
| caffeic acid | H | ferulic acid |
| ferulic acid | H | caffeic acid |
| H | caffeic acid | ferulic acid |
| H | ferulic acid | caffeic acid |

The use of chlorogenic acids as a taste modifier is more fully described in WO2002/100192, which is fully incorporated herein by reference.

According to other illustrative embodiments, the sweet taste modifier of the composition comprises one or more of a phenyl pyridyl ketone of the following formulas:

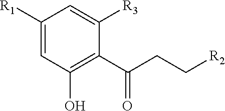

wherein R₁ may be H, OH, O(CH₂)₂OH, OCH₂OCH₃ or

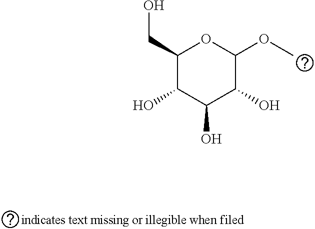

R₂ may be selected from a range of 5- and 6-membered heterocyclic rings, and wherein R₃ may be H or OH.

The structure and use of phenyl pyridyl ketones as a taste modifier is more fully described in WO2012/123475 and WO 2009/105906, which are fully incorporated herein by reference.

According to other illustrative embodiments, the sweet taste modifier of the composition may comprise rebaudioside A as described in WO2007/121605, WO2008/049256 and WO2009/023975, and blends of rebaudioside A and stevioside as described in WO2013/060746, all of which are incorporated by reference.

According to other illustrative embodiments, the sweet taste modifier of the composition may comprise one or more compounds defined by the following formula and derivatives thereof (such as salts thereof):

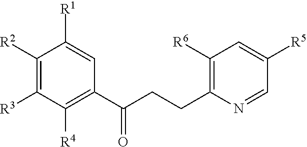

in which
R¹ is H, methyl or ethyl;
R² is H, OH, fluorine, C₁-C₄ linear or branched alkyl, C₁-C₆ alkoxy wherein the alkyl group is linear or branched, or a C₃-C₅ cycloalkyl moiety;
R³ is H, methoxy, methyl or ethyl;
or R² and R³ together forma bridging moiety —O—CH₂—O— between the phenyl carbon atoms to which they are connected;
R⁴ is OH or methoxy; and
R⁵ and R⁶ are independently H or methyl;
R¹, R², R³, R⁴, R⁵ and R⁶ are such that,
(i) when R² and R³ together form a bridging moiety —O—CH₂—O— between the phenyl carbon atoms to which they are connected, R¹, R⁵, R⁶ are H, and R⁴ is OH; and
(ii) when R⁴ is OH and R¹-R³ are H, at least one of R⁵, R⁶ is methyl.

These compounds are more fully described in WO2011/004016, which is fully incorporated herein by reference.

According to other illustrative embodiments, the sweet taste modifier of the composition may comprise one or more compounds defined by the following formula and derivatives thereof (such as salts thereof):

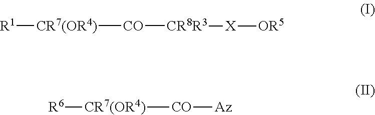

wherein:
X represents a covalent bond; C₁-C₅ alkyl or C₂-C₅ alkenyl, each optionally substituted with 1-4 substituents selected from hydroxyl, C₁-C₃ alkyl and C₁-C₃ alkenyl;
R¹ and R⁷ independently represent hydrogen; or C₁-C₈ alkyl, C₂-C₈ alkenyl or C₃-C₈ cycloalkyl, each optionally substituted with 1-8 substituents selected from hydroxyl, oxo, C₁-C₃, alkyl; C₂-C₃ alkenyl and C₁-C₃ carboxyl;
R² represents hydrogen; or C₁-C₆ alkyl, C₂-C₆ alkenyl, C₃-C₆ cycloalkyl C₃-C₆ cycloalkenyl or C₁-C₆ acyl, each optionally substituted with 1-6 substituents selected from hydroxyl, C₁-C₃ alkyl and C₂-C₃ alkenyl;
R³ and R⁸ independently represent hydrogen; hydroxyl; or C₁-C₈ alkyl, C₂-C₈ alkenyl, or C₃-C₈ cycloalkyl, each optionally substituted with 1-8 substituents selected from hydroxyl, C₁-C₃ alkyl and C₂-C₃ alkenyl;
R⁴ represents hydrogen, C₁-C₃, acyl or C₁-C₃ alkyl;
R⁵ represents hydrogen, C₃-C₃ acyl, C₁-C₃ alkyl, a phosphate group selected from mono-, di- and triphosphate or a C₃-C₅ carboxyacyl, optionally further substituted with 1-3 substituents selected from hydroxyl, oxo, C₁-C₃ carboxyl;
R⁶ represents C₂-C₆ alkyl or C₄-C₆ cycloalkyl each optionally substituted with 1-6 hydroxyl groups and each optionally substituted with 1-4 substituents selected from C₁-C₃ alkyl and C₃-C₃ carboxyl; and
Az represents an amino acid residue, and the CO-Az bond represents an amide bond;
   provided that R¹—CR⁷(OR⁴)—CO— does not represent a hexose or heptose sugar acid residue comprising more than 4 hydroxyl groups.

These compounds are more fully described in WO2005/102071 and WO/2006/009425, which are fully incorporated herein by reference.

According to other illustrative embodiments, the sweet taste modifier of the composition may comprise choline chloride in amounts ranging from 500 ppb to 500 ppm, particularly from about 10 ppm to about 50 ppm, as described in WO2011/073187, which is incorporated by reference.

According to other illustrative embodiments, the sweet taste modifier of the composition may comprise gamma amino butyric acid as described in WO2011/039340, which is incorporated by reference.

According to other illustrative embodiments, the sweet taste modifier of the composition may comprise a mega fatty complex as described in WO2016/062743, which is incorporated by reference. Mega fatty complex refers to a composition prepared from arachidonic acid-enriched single cell oils. Single cell oils are edible oils that are extracted from single cell microorganisms, such as algae, bacteria and yeast. Methods for the preparation of mega fatty complex is also described in U.S. Pat. No. 5,178,892 and US 2007/009642.

According to other illustrative embodiments, the sweet taste modifier of the composition may comprise the sweetness modifying compositions disclosed in US 2022/0104524A1 and 2020/0345049A1, which are fully incorporated herein by reference.

According to certain illustrative embodiments, the drum dried cocoa pulp composition ingredient comprises 70 weight percent or greater dried cocoa pulp, 71 weight percent or greater dried cocoa pulp, 72 weight percent or greater dried cocoa pulp, 73 weight percent or greater dried cocoa pulp, 74 weight percent or greater dried cocoa pulp, 75 weight percent or greater dried cocoa pulp, 76 weight percent or greater dried cocoa pulp, 77 weight percent or greater dried cocoa pulp, 78 weight percent or greater dried cocoa pulp, 79 weight percent or greater dried cocoa pulp, 80 weight percent or greater dried cocoa pulp, 81 weight percent or greater dried cocoa pulp, 82 weight percent or greater dried cocoa pulp, 83 weight percent or greater dried cocoa pulp, 84 weight percent or greater dried cocoa pulp, 85 weight percent or greater dried cocoa pulp, 86 weight percent or greater dried cocoa pulp, 87 weight percent or greater dried cocoa pulp, 88 weight percent or greater dried cocoa pulp, 89 weight percent or greater dried cocoa pulp, 90 weight percent or greater dried cocoa pulp, 91 weight percent or greater dried cocoa pulp, 92 weight percent or greater dried cocoa pulp, 93 weight percent or greater dried cocoa pulp, 94 weight percent or greater dried cocoa pulp, or 95 weight percent or greater dried cocoa pulp, based on the total weight of the drum dried cocoa pulp composition ingredient.

According to certain illustrative embodiments, the drum dried cocoa pulp composition ingredient comprises 20 weight percent or less of at least one carrier, 15 weight percent or less of at least one carrier, 10 weight percent or less of at least one carrier, 9 weight percent or less of at least one carrier, 8 weight percent or less of at least one carrier, 7 weight percent or less of at least one carrier, 6 weight percent or less of at least one carrier, 5 weight percent or less of at least one carrier, 4 weight percent or less of at least one carrier, 3 weight percent or less of at least one carrier, 2 weight percent or less of at least one carrier, 1 weight percent or less of at least one carrier, based on the total weight of the drum dried cocoa pulp composition ingredient.

According to certain illustrative embodiments, the drum dried cocoa pulp composition ingredient comprises 5 weight percent or less, 4 weight percent or less, 3 weight percent or less, 2 weight percent or less, 1 weight percent or less, 0.9 weight percent or less, 0.8 weight percent or less, 0.7 weight percent or less, 0.6 weight percent or less, 0.5 weight percent or less, 0.4 weight percent or less, 0.3 weight percent or less, 0.2 weight percent or less, 0.1 weight percent or less, 0.09 weight percent or less, 0.08 weight percent or less, 0.07 weight percent or less, 0.06 weight percent or less, 0.05 weight percent or less, 0.04 weight percent or less, 0.03 weight percent or less, 0.02 weight percent or less, 0.01 weight percent or less, 0.009 weight percent or less, 0.008 weight percent or less, 0.007 weight percent or less, 0.006 weight percent or less, 0.005 weight percent or less, 0.004 weight percent or less, 0.003 weight percent or less, 0.002 weight percent or less, 0.001 weight percent or less of at least one functional additive selected from at least one natural flavor, at least one sweet taste modifier, a taste masking additive, at least one mouthfeel modifier and combinations thereof, based on the total weight of the drum dried cocoa pulp composition ingredient.

The solids content of the drum dried cocoa pulp liquid may be in the range of about 10 to about 25 weight percent. According to certain embodiments, the solids content of the drum dried cocoa pulp liquid is 25 weight percent or less, or 20 weight percent or less, or weight percent or less, or 10 weight percent or less, or 5 weight percent or less.

The solids content of the drum dried cocoa pulp and carrier may be in the range of about 10 to about 50 weight percent, or about 10 to about 54 weight percent, or about 10 to about 60 weight percent. According to certain embodiments, the solids content of the drum dried cocoa pulp and carrier may be 50 weight percent or less, or 45 weight percent or less, or weight percent or less, or 35 weight percent or less, or 30 weight percent or less, or 25 weight percent or less.

Also disclosed is a process of making the ingredient composition. Cocoa pods are harvested, and the outer husks are removed. After the husk is removed from the cocoa pod, the cocoa bean is further processed to separate the cocoa pulp from the cocoa bean, and to obtain a liquid cocoa pulp. This may be accomplished by, for example, subjecting the cocoa bean to a mechanical pressing operation to obtain the cocoa pulp juice. The obtained cocoa pulp juice may be concentrated and pasteurized for subsequent use, but this is not required.

The process of making the drum dried cocoa pulp composition ingredient comprises combining the cocoa pulp, which is a waste byproduct of cocoa bean harvesting, with a suitable carrier and drum drying the combination of the cocoa pulp and carrier. The mixture of the cocoa pulp juice with the carrier increases the dry material in the mixture to improve the structure and make it less hygroscopic. The process of drum drying is also known as roll drying. Drum drying is a continuous process that creates dry powders and flakes from a liquid or paste feed that is brought into contact with rotating drums. The liquid or paste feed is dip fed, poured, roller fed, or sprayed onto or in between two rotating drums. The drums are heated internally with, for example, steam to increase the surface temperature of the drums. As the liquid or paste feed is brough into contact with the surface of the rotating drums, heat is transferred from the hot drum surfaces to the feed, and it adheres and dries to the surfaces of the drums. The dried material is separated from the rotating drums with a blade, knife, or scraper. The separated dried material is then milled into a powder and collected.

According to alternative embodiments, the process of making the drum dried cocoa pulp composition ingredient comprises combining the cocoa pulp, which is a waste byproduct of cocoa bean harvesting, with a suitable carrier and at least one functional additive, and drum drying the combination.

The temperature of the surface of the rotating drums of the drum drying process may be in the range of about 100° C. to about 150° C. According to certain embodiments, during the drum drying process the temperature of the cocoa pulp composition does not exceed 100° C. Maintaining the cocoa pulp composition at a temperature that does not excess 100° C. during the drum drying process may be accomplished by adding a suitable amount of water to the mixture of cocoa pulp and the at least one carrier, and as the water evaporates the temperature of the composition does not exceed 100° C. According to certain embodiments, the drum dried cocoa pulp composition is cooled by blowing air across the drum dried composition as it is removed from the surface of the rotating drum dryers.

The rotational speed of the rotating drums of the drum drying process may be in the range of about 0.5 RPM to about 2 RPM, or from about 0.7 RPM to about 1.5 RPM, or from about 1 RPM to about 1.5 RPM.

The internal stream pressure of the rotating drums of the drum drying process is greater than 1 bar, or greater than 2 bar, or greater than 3 bar, or greater than 4 bar.

The gap between adjacent rotating drums of the drum drying process may be in the range of about 0.1 mm to about 1 mm, or from about 0.25 mm to about 1 mm, or from about 0.3 mm to about 0.8 mm.

As a result of the drum drying process, the drum dried cocoa pulp has a moisture content of 10% or less, 9% or less, 8% or less, 7% or less, 6% or less, 5% or less, 4 or less, 3% or less, 2% or less, or 1% or less. According to certain illustrative embodiments, as a result of the drum drying process, the drum dried cocoa pulp has a moisture content in the range of about 1% to 6%, or in the range of about 2% to about 6%, or in the range of about 3% to about 6%.

According to certain illustrative embodiments, the size of the drum dried cocoa pulp is first reduced. This is accomplished by any known process for reducing the size of a material. For example, and without limitation, the size of the dried cocoa pulp may be reduced by granulating, mixing, grinding, grating, shredding, mincing, crushing, crumbling, comminuting, pulverizing, stirring, milling, macerating, rolling, blending and like processes. The size of the dried cocoa pulp can be reduced under cold temperatures by, for example, exposure to a cryogenic fluid. Cryogenic fluids are cooling or chilling fluids that are liquids at or below a temperature of about −150° C. Suitable cryogenic fluids include, for example, but are not limited to liquid argon, liquid carbon dioxide, liquid helium, liquid nitrogen, and the like. According to certain embodiments, the cryogenic fluid is liquid nitrogen. According to other embodiments, the cryogenic fluid is liquid carbon dioxide. The cryogenic cooling or chilling of the dried cocoa pulp within the cryogen treatment vessel with the cryogenic fluid can be carried out at any cryogenic temperatures that are suitable to sufficiently chill or cool the dried cocoa pulp for subsequent processing. By way of illustration, and not in limitation, the cryogenic cooling or chilling of the dried cocoa pulp with the cryogenic fluid can be carried out at temperatures at or below −150° C., at or below −160° C., at or below −170° C., at or below −180° C., at or below −190° C., or at or below −200° C., or lower temperatures.

Also provided is a process or use of a composition comprising drum dried cocoa pulp, and at least one carrier, and optionally at least one functional additive, to reduce or eliminate entirely added refined sugar in a chocolate consumable. According to certain illustrative embodiments, at least 25 of the added refined sugar in a consumable is replaced by the drum dried cocoa pulp composition, at least 30 of the added refined sugar in a consumable is replaced by the drum dried cocoa pulp composition, at least 40 of the added refined sugar in a consumable is replaced by the drum dried cocoa pulp composition, at least 50 of the added refined sugar in a consumable is replaced by the drum dried cocoa pulp composition, at least 60 of the added refined sugar in a consumable is replaced by the drum dried cocoa pulp composition, at least 70 of the added refined sugar in a consumable is replaced by the drum dried cocoa pulp composition, at least 75 of the added refined sugar in a consumable is replaced by the drum dried cocoa pulp composition, at least 80 of the added refined sugar in a consumable is replaced by the drum dried cocoa pulp composition, at least 90 of the added refined sugar in a consumable is replaced by the drum dried cocoa pulp composition, or at least 95 of the added refined sugar in a consumable is replaced by the drum dried cocoa pulp composition. According to certain embodiments, 100% of the added refined sugar in a consumable is replaced by the drum dried cocoa pulp composition to prepare a zero or no sugar consumable.

Also disclosed is a process for making a chocolate consumable with the drum dried cocoa pulp composition ingredient. The process of making a chocolate consumable includes adding an amount of the drum dried cocoa pulp composition ingredient to the other ingredients typically used to prepare a chocolate consumable or chocolate end product. The process of making a chocolate consumable includes adding an amount of the drum dried cocoa pulp composition ingredient to the other ingredients typically used to prepare a white-type chocolate consumable, milk-type chocolate consumable, a dark-type chocolate consumable, or a ruby-type chocolate consumable. According to certain embodiments, the process of making a chocolate consumable includes adding an amount of the drum dried cocoa pulp composition ingredient to the other ingredients typically used to prepare a milk-type chocolate consumable or a dark-type chocolate consumable. According to certain embodiments, the process of making a chocolate consumable includes adding an amount of the dried cocoa pulp composition ingredient to the other ingredients typically used to prepare a milk-type chocolate consumable. According to certain embodiments, the process of making a chocolate consumable includes adding an amount of the drum dried cocoa pulp composition ingredient to the other ingredients typically used to prepare a dark-type chocolate consumable.

According to certain embodiments, the process of making an edible end product or consumable comprises preparing a chocolate consumable or edible chocolate end product. The other standard ingredients for making a chocolate consumable or edible chocolate end product may include, for example, chocolate liquor (formed by grinding a cocoa nib), alkalized chocolate liquor, partially defatted or fully defatted cocoa solids, alkalized partially defatted or fully defatted cocoa solids, partially defatted or fully defatted cocoa powder, alkalized partially defatted or fully defatted cocoa powder, cocoa butter, and butter fat. The process includes combining the drum dried cocoa pulp composition ingredient with cocoa liquor, cocoa butter and an emulsifier. According to certain embodiments, the process includes combining the drum dried cocoa pulp composition ingredient with cocoa liquor, cocoa butter and lecithin. According to certain embodiments, the method of making a chocolate consumable or edible chocolate end product comprises combining the drum dried cocoa pulp composition ingredient with cocoa liquor, cocoa butter and lecithin without adding any refined sugar. The chocolate consumable or edible chocolate end product may be formed into bars, blocks, chips, cubes, flakes, spheres (hollow or solid), wafers, or any other desired shape.

The process for making a chocolate consumable or edible chocolate edible product comprises preparing or obtaining the drum dried cocoa pulp composition ingredient described herein. The drum dried cocoa pulp composition ingredient is combined with cocoa butter, cocoa liquor, and, optionally, an emulsifier such as lecithin. These combined materials are mixed together in a mixing vessel at a temperature to sufficiently melt the materials. The mixture of materials is then subjected to a refining step to reduce the particle sizes of the cocoa solids and a conching step to coat the cocoa particles or better distribute cocoa particles into the cocoa butter fat phase. The conching step develops viscosity, texture and flavor of the chocolate consumable mixture. Following the conching step, the chocolate consumable mixture is cooled and formed into a desired shape.

The process of the present disclosure may be used to prepare a wide variety of chocolate compositions and edible chocolate end products. The term “chocolate” refers to all chocolate or chocolate-like compositions with a fat-based component phase or fat-like composition. The term chocolate includes standardized and non-standardized chocolates, including chocolates with compositions conforming to the U.S. Standards of Identity (SOI) and compositions not conforming to U.S. Standards of Identity (non-SOI), respectively. For example, and without limitation, these include dark chocolate, baking chocolate, milk chocolate, sweet chocolate, mixed dairy product chocolate, low fat chocolate, white chocolate, aerated chocolates, compound coatings, non-standardized chocolates, and chocolate-like compositions, unless specified otherwise.

According to certain embodiments, the process for making a chocolate consumable or edible chocolate end product does not comprise adding refined sugar to the ingredients used to make the consumable or edible end product. The chocolate consumable or edible chocolate product prepared by the process disclosed herein may be referred to as a zero added sugar consumable or edible end product.

According to certain embodiments, the process for making a chocolate consumable or edible chocolate end product comprises adding sugar to the ingredients used to make the consumable or edible end product in an amount of at least 50% and less than 100%. The chocolate consumable or edible chocolate product prepared by the process disclosed herein may be referred to as a reduced sugar consumable or edible end product. According to this embodiment, a sweetener such as, but not limited to, sugar may be included in the consumable composition.

According to certain embodiments, the process for making a chocolate consumable or edible chocolate end product does not comprise adding a bulking agent such as polydextrose, cellulose, cellulose derivatives, malodextrin, gum arabic, or the like to the ingredients used to make the consumable or edible end product.

According to certain embodiments, the chocolate consumable or chocolate edible end product may comprise from about 15 to about 50 weight percent of the drum dried cocoa pulp composition ingredient and from 50 to about 85 weight percent of the other ingredients typically used to prepare a chocolate consumable or chocolate end product, based on the total weight of the chocolate consumable or chocolate edible end product. According to certain embodiments, the chocolate consumable or chocolate edible end product may comprise from about 25 to about 40 weight percent of the drum dried cocoa pulp composition ingredient and from 60 to about 75 weight percent of the other ingredients typically used to prepare a chocolate consumable or chocolate end product, based on the total weight of the chocolate consumable or chocolate edible end product.

According to certain embodiments, the chocolate consumable or chocolate edible end product may comprise from about 15 to about 50 weight percent of the drum dried cocoa pulp composition ingredient and from 50 to about 85 weight percent of the other ingredients typically used to prepare a white-type chocolate consumable, milk-type chocolate consumable, a dark-type chocolate consumable, or a ruby-type chocolate consumable, based on the total weight of the chocolate consumable or chocolate edible end product. According to certain embodiments, the chocolate consumable or chocolate edible end product may comprise from about 25 to about 40 weight percent of the drum dried cocoa pulp composition ingredient and from 60 to about 75 weight percent of the other ingredients typically used to prepare a white-type chocolate consumable, milk-type chocolate consumable, a dark-type chocolate consumable, or a ruby-type chocolate consumable, based on the total weight of the chocolate consumable or chocolate edible end product.

According to certain embodiments, the chocolate consumable or chocolate edible end product may comprise from about 15 to about 50 weight percent of the drum dried cocoa pulp composition ingredient and from 50 to about 85 weight percent of chocolate liquor (formed by grinding a cocoa nib), partially defatted or fully defatted cocoa solids, partially defatted or fully defatted cocoa powder, cocoa butter, butter fat, and emulsifier, based on the total weight of the chocolate consumable or chocolate edible end product. According to certain embodiments, the chocolate consumable or chocolate edible end product may comprise from about 25 to about 40 weight percent of the drum dried cocoa pulp composition ingredient and from 60 to about 75 weight percent of chocolate liquor (formed by grinding a cocoa nib), partially defatted or fully defatted cocoa solids, partially defatted or fully defatted cocoa powder, cocoa butter, butter fat, and emulsifier, based on the total weight of the chocolate consumable or chocolate edible end product.

According to certain embodiments, the chocolate consumable or chocolate edible end product may comprise from about 15 to about 50 weight percent of the drum dried cocoa pulp composition ingredient and from 50 to about 85 weight percent of chocolate liquor (formed by grinding a cocoa nib), cocoa butter, and emulsifier, based on the total weight of the chocolate consumable or chocolate edible end product. According to certain embodiments, the chocolate consumable or chocolate edible end product may comprise from about 25 to about weight percent of the drum dried cocoa pulp composition ingredient and from 60 to about 75 weight percent of chocolate liquor (formed by grinding a cocoa nib), cocoa butter, and emulsifier, based on the total weight of the chocolate consumable or chocolate edible end product.

### EXAMPLES

### Example 1—Preparation of Composition Ingredient for Dark Chocolate Consumable

| | Weight (%) | Weight (g) | Volume (ml) |
|---|---|---|---|
| Cocoa Pulp, Liquid | 95.075 | 400 | 372.439 |
| Cocoa Powder | 4.754 | 200 | 20 |
| Vanilla Flavor | 0.024 | 0.100 | 0.100 |
| Sweet Taste Modifier | 0.005 | 0.022 | 0.022 |
| Taste Masker | 0.095 | 0.400 | 0.400 |
| Mouthfeel Improver | 0.048 | 0.200 | 0.200 |
| Total | 100.00 | 422.722 | 393.161 |

### Example 2—Preparation of Composition Ingredient for Milk Chocolate Consumable

| | Weight (%) | Weight (g) | Volume (ml) |
|---|---|---|---|
| Cocoa Pulp, Liquid | 95.075 | 400 | 372.439 |
| Skim Milk Powder | 4.754 | 200 | 20 |
| Vanilla Flavor | 0.024 | 0.100 | 0.100 |
| Sweet Taste Modifier | 0.005 | 0.022 | 0.022 |
| Taste Masker | 0.095 | 0.400 | 0.400 |
| Mouthfeel Improver | 0.048 | 0.200 | 0.200 |
| Total | 100.00 | 422.722 | 393.161 |

### Example 3—Preparation of Dark Chocolate Consumable

| | Weight (%) | Weight (g) | Volume (ml) |
|---|---|---|---|
| Dried Cocoa Pulp Ingredient | 27.500 | 27.500 | 27.500 |

Refining Stage

| | | | |
|---|---|---|---|
| Cocoa Mass | 27.000 | 27.000 | 0.000 |
| Soy Lecithin | 0.050 | 0.050 | 0.050 |

Conching Stage

| | | | |
|---|---|---|---|
| Cocoa Mass | 35.000 | 35.000 | 0.000 |
| Cocoa Butter | 10.000 | 10.000 | 10.000 |
| Soy Lethicin | 0.450 | 0.450 | 0.450 |
| Total | 100.00 | 100.00 | 38.00 |

### Example 4—Preparation of Milk Chocolate Consumable

| | Weight (%) | Weight (g) | Volume (ml) |
|---|---|---|---|
| Dried Cocoa Pulp Ingredient | 39.500 | 39.500 | 39.500 |

Refining Stage

| | | | |
|---|---|---|---|
| Milk Powder, Skimmed | 16 | 16 | 16 |
| Cocoa Mass | 13 | 13 | 13 |
| Cocoa Butter | 17.500 | 17.500 | 17.500 |
| Butter Fat, Anhydrous | 3.500 | 3.500 | 3.500 |
| Soy Lecithin | 0.050 | 0.050 | 0.050 |

Conching Stage

| | | | |
|---|---|---|---|
| Cocoa Butter | 10 | 10 | 10 |
| Soy Lecithin | 0.450 | 0.450 | 0.450 |
| Total | 100.00 | 100.00 | 97.667 |

### Comparative Example 5—Preparation of Dark Chocolate Consumable

| | Weight (%) | Weight (g) | Volume (ml) |
|---|---|---|---|
| Sucrose, Crystalline | 27.500 | 27.500 | 27.500 |

Refining Stage

| | | | |
|---|---|---|---|
| Cocoa Mass | 27.000 | 27.000 | 0.000 |
| Soy Lecithin | 0.050 | 0.050 | 0.050 |

Conching Stage

| | | | |
|---|---|---|---|
| Cocoa Mass | 35.000 | 35.000 | 0.000 |
| Cocoa Butter | 10.000 | 10.000 | 10.000 |
| Soy Lethicin | 0.450 | 0.450 | 0.450 |
| Total | 100.00 | 100.00 | 38.00 |

### Comparative Example 6—Preparation of Milk Chocolate Consumable

| | Weight (%) | Weight (g) | Volume (ml) |
|---|---|---|---|
| Sucrose, Crystalline | 39.500 | 39.500 | 39.500 |

Refining Stage

| | | | |
|---|---|---|---|
| Milk Powder, Skimmed | 16.000 | 16.000 | 26.667 |
| Cocoa Mass | 13.000 | 13.000 | 0.000 |
| Cocoa Butter | 17.500 | 17.500 | 17.500 |
| Butter Fat, Anhydrous | 3.500 | 3.500 | 3.500 |
| Soy Lecithin | 0.050 | 0.050 | 0.050 |

Conching Stage

| | | | |
|---|---|---|---|
| Cocoa Butter | 10.000 | 10.000 | 10.000 |
| Soy Lethicin | 0.450 | 0.450 | 0.450 |
| Total | 100.00 | 100.00 | 97.667c |

### Refined Sugar Reduction Analysis

The dark chocolate consumable of Example 3 was prepared with the drum dried dark chocolate consumable composition ingredient of Example 1 as a complete replacement for white crystalline sucrose. The total nutritional sugar content of the dark chocolate consumable of Example 3 is 17.2%. The entirety of the total nutritional sugar content of the dark chocolate consumable of Example 3 is contributed by the drum dried dark chocolate consumable composition ingredient of Example 1. The total nutritional sugar content of the dark chocolate consumable of Example 3 was compared to the total nutritional sugar content of the dark chocolate consumable of Comparative Example 5. The dark chocolate consumable of Comparative Example 5 was prepared with white crystalline sucrose. The total nutritional sugar content of the Dark Chocolate consumable of Comparative Example 5 is 27.69%. The entirety of the total nutritional sugar content of the dark chocolate consumable of Comparative Example 5 is contributed by the addition of the refined white crystalline sugar. These results demonstrate that the use of the drum dried dark chocolate consumable composition ingredient of Example 1 as a complete replacement for refined white crystalline sugar to prepare a dark chocolate consumable results in a 37% reduction of sugar in the consumable.

The milk chocolate consumable of Example 4 was prepared with the drum dried milk chocolate consumable composition ingredient of Example 2 as a complete replacement for white crystalline sucrose. The total nutritional sugar content of the milk chocolate consumable of Example 4 is 36.24%. The total nutritional sugar content of the milk chocolate consumable of Example 4 is mainly contributed by the drum dried milk chocolate consumable composition ingredient of Example 2. The total nutritional sugar content of the milk chocolate consumable of Example 4 was compared to the total nutritional sugar content of the milk chocolate consumable of Comparative Example 6. The milk chocolate consumable of Comparative Example 6 was prepared with white crystalline sucrose. The total nutritional sugar content of the milk chocolate consumable of Comparative Example 6 is 47.70%. The entirety of the total nutritional sugar content of the milk chocolate consumable of Comparative Example 6 is contributed by the milk powder carrier and the addition of the refined white crystalline sugar. These results demonstrate that the use of the drum dried milk chocolate consumable composition ingredient of Example 2 as a complete replacement for refined white crystalline sugar to prepare a milk chocolate consumable results in a 24% reduction of sugar in the consumable.

### Sensory Evaluations

Sensory evaluations were carried out on inventive samples of milk-type (Inventive Examples 9) and dark-type (Inventive example 12) chocolate consumables prepared with the dried cocoa composition ingredient. The inventive samples were compared against commercially available milk-type (Comparative Examples 7 and 8) and dark-type (Comparative Examples 10 and 11) chocolates from the open market. The following samples were evaluated:

| | | Cocoa |
|---|---|---|
| Example | Chocolate Type | Content |
| Comparative Example 7 | Standard Milk-type Chocolate | 38% |
| Comparative Example 8 | Ruby Pink Chocolate | 40% |
| Inventive Example 9 | Milk-type chocolate with dried | 40.5% |
| | cocoa pulp composition ingredient | |
| Comparative Example 10 | Standard Dark-type Chocolate | 49% |
| Comparative Example 11 | 100% cocoafruit | 78% |
| Inventive Example 12 | Dark-type chocolate with dried | 72% |
| | cocoa pulp composition ingredient | |

Trained panelists were prescreened for sensory acuity. The trained panelists individually rated the intensity attributes of each sample on a point scale of 0-100. A 10-point difference represents a slight gap in the same attribute between samples. A 20-point difference represents a clear difference in the same attribute between samples. Each sample was evaluated in sequential monadic order. Red light was used to cover the color differences between the samples. Water and crackers were used by the panelists to cleanse the palate between samples. The individual scores were collected for separate analysis of dark-type chocolates and milk-type chocolates. Panelists reported their individual sensory experiences with the samples by identifying flavor attributes associated with each sample. Each of the flavor attributes has a description.

While certain illustrative embodiments of the present disclosure have been described herein, it is to be understood that other embodiments may be used or modifications and additions may be made to the described embodiments for performing the same function of the present embodiments without deviating therefrom. Further, all embodiments disclosed are not necessarily in the alternative, as various embodiments of the invention may be combined to provide the desired characteristics. Variations can be made by one having ordinary skill in the art without departing from the spirit and scope of the disclosure. Therefore, the present embodiments should not be limited to any single embodiment, but rather construed in breadth and scope in accordance with the recitation of the attached claims.

1. A composition comprising:
drum dried cocoa pulp; and
at least one carrier selected from the group consisting of animal-derived milk powder, plant-derived milk powder and combinations thereof.

2. The composition of claim 1, wherein the composition does not comprise any added refined sugar.

3. The composition of claim 1, wherein said animal-derived milk powder is selected from the group consisting of animal-derived non-fat milk powder, animal-derived skim milk powder, animal-derived whole milk powder and combinations thereof.

4. The composition of claim 1, wherein said plant-derived milk powder is selected from the group consisting of almond milk powder, oat milk powder, pea milk powder, soy milk powder and mixtures thereof.

5. The composition of claim 1, wherein the composition further comprises at least one functional additive selected from the group consisting of natural flavor, sweet taste modifier, taste masker, mouthfeel improver and combinations thereof.

6. The composition of claim 5, wherein the composition comprises 70 weight percent or greater drum dried cocoa pulp, 20 weight percent or less of at least one carrier, and 5 weight percent or less, of at least one functional additive selected from a natural flavor, a sweet taste modifier, a taste masking additive, a mouthfeel modifier and combinations thereof, based on the total weight of the composition.

7. The composition of claim 1, wherein the drum dried cocoa pulp has a moisture content of 6% or less.

8. A process of making a composition comprising drum drying cocoa pulp with a carrier selected from the group consisting of animal-derived milk powder, plant-derived milk powder and combinations thereof.

9. The process of claim 8, wherein the drum drying is carried out at a temperature in the range of 100° C. to 150° C.

10. The process of claim 8, comprising combining at least one functional additive selected from a natural flavor, sweet taste modifier, a taste masker, and a mouthfeel improver with the drum dried cocoa pulp and the at least one carrier after drum drying.

11. The process of claim 8, comprising combining at least one functional additive selected from a natural flavor, sweet taste modifier, a taste masker, and a mouthfeel improver with the drum dried cocoa pulp and the at least one carrier during drum drying.

12. A composition prepared by the process of claim 8.

13. A consumable comprising the composition of claim 1, cocoa liquor and cocoa butter.

14. The consumable of claim 13, further comprising an emulsifier.

15. The consumable of claim 14, comprising at least 30 weight percent of said drum dried cocoa pulp composition and up to 70 weight percent of non-cocoa pulp cocoa solids, cocoa butter and other additives.

16. The consumable of claim 15, comprising at least 40 weight percent of said drum dried cocoa pulp composition and up to 60 weight percent of non-cocoa pulp cocoa solids, cocoa butter and other additives.

17. The consumable of claim 16, comprising at least 70 weight percent of said drum dried cocoa pulp composition and up to 30 weight percent of non-cocoa pulp cocoa solids, cocoa butter and other additives.

18. A consumable comprising the composition prepared by the process of claim 8, cocoa liquor and cocoa butter and optionally an emulsifier.

19. (canceled)

20. A process for eliminating or reducing the amount of refined sugar in a chocolate consumable comprising adding the composition of claim 1 to said chocolate consumable.
